(19) United States
(12) Patent Application Publication
(10) Pub. No.: US 2020/0313240 A1
(43) Pub. Date: Oct. 1, 2020

(54) ELECTROLYTE ADDITIVE, ELECTROLYTE AND LITHIUM ION SECONDARY BATTERY CONTAINING THE SAME

(71) Applicant: MURATA MANUFACTURING CO., LTD., Kyoto-fu (JP)

(72) Inventors: Jin PAN, Shanghai (CN); Cheng ZHU, Shanghai (CN); Yingtao CHEN, Shanghai (CN)

(21) Appl. No.: 16/822,897

(22) Filed: Mar. 18, 2020

(30) Foreign Application Priority Data
Mar. 29, 2019 (CN) 201910251384.7

(51) Int. Cl. H01M 10/0567; H01M 10/0569; H01M 10/0525; H01M 10/26; H01M 2/16; H01M 4/131

(52) U.S. Cl. CPC H01M 10/0567; H01M 10/0569; H01M 10/0525; H01M 2004/028; H01M 2/1673; H01M 4/131; H01M 10/26

(57) ABSTRACT

The present disclosure provides an electrolyte additive, an electrolyte and a lithium ion secondary battery containing the same. The electrolyte additive has a structure of Formula (1), wherein R₁ is hydrogen, a phenyl, a nitrile group, a cyano group substituted by one or more C₁ to C₆ alkyls, or a C₁ to C₆ alkyl optionally substituted by one or more C₁ to C₆ alkyls or C₂ to C₆ alkenyls, and each of R₂ to R₅ is independently selected from hydrogen or a C₁ to C₆ alkyl optionally substituted by one or more C₁ to C₆ alkyls. By means of the electrolyte additive, the electrolyte and the lithium ion secondary battery containing the same of the present disclosure, a technical effect of improving and enhancing high-temperature storage performance and high-temperature cycle performance of the lithium ion secondary battery is achieved.

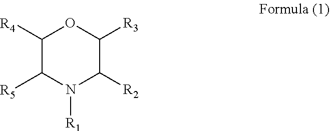

### INCORPORATION BY REFERENCE

This application claims the benefit of Chinese Patent Application No. 201910251384.7, filed on Mar. 29, 2019, and titled “Electrolyte Additive, Electrolyte and Lithium Ion Secondary Battery Containing the Same”, the entire contents of which are incorporated by reference herein.

### TECHNICAL FIELD

The present disclosure relates to the field of lithium ion secondary batteries, and in particular, to an electrolyte additive, an electrolyte and a lithium ion secondary battery containing the same.

### BACKGROUND

In recent years, along with continuous development of an electronic technology, the requirements for people to a battery device for supporting energy supply of an electronic device are also continuously increased. Nowadays, batteries capable of storing a high amount of electricity and outputting high power are desired. Traditional lead-acid battery and nickel-metal hydride battery and the like cannot meet the requirements of mobile equipment, such as a smartphone, and a new-type electronic product of fixed equipment, such as a power storage system. Therefore, a lithium battery has been attracted an extensive attention. During the development of the lithium battery, capacity and performance thereof have been more effectively improved.

At present, electrolyte of an widely used lithium ion secondary battery is mainly composed of a mixed solution using lithium hexafluorophosphate as conductive lithium salt and using cyclic carbonic ester and chain carbonic ester as major solvents. However, the above electrolyte still has many disadvantages, especially in a condition of high voltage, the performance of the lithium ion battery is poor, for example poor high-temperature cycle performance and poor high-temperature storage performance. When the lithium ion secondary battery is charged in the high voltage, positive electrode materials, such as lithium cobaltate and ternary material, easily result in transition metal being dissolved out, and the dissolved-out transition metal may be migrated to a negative electrode so as to be reduced, and then deposited on the surfaces of the negative electrode. In such case, the storage performance of the battery is deteriorated on one hand, and gas-producing is seriously occurred; and on the other hand, a positive electrode structure is deteriorated, and the cyclic stability of the battery is reduced.

In order to improve the high-temperature storage performance of the battery, some functional additives are paid more attention to on electrolyte development. For example, a compound containing an unsaturated bond, by means of forming membranes onto the positive electrode and negative electrode, is capable of inhibiting a dissolving-out amount of cobalt. For another example, a nitrile-based compound, by means of complexing of a nitrile bond and a metal ion, is capable of improving the high-temperature storage performance of the battery. However, the improvement of the storage performance of the battery is generally accompanied with great increase of battery impedance and decrease of the cyclic performance. In order to improve the cyclic performance of the battery, it is researched and developed that the other functional additives are added into the electrolyte of the lithium ion secondary battery. In prior art, lithium difluorooxalatoborate is generally used as a high-voltage membrane forming additive of the lithium ion battery electrolyte. The lithium difluorooxalatoborate may form layers of a stable solid electrolyte membrane (SEI membrane) on all the surfaces of the negative electrode in a first charging-discharging process of the battery, thereby the surfaces of the negative electrode are optimized, and oxidative decomposition of an electrolyte major solvent on the electrode surfaces is reduced. However, although this type of the electrolyte additive is capable of improving the cyclic performance of the lithium ion battery at 3 V to 4.5 V, the high-temperature storage performance of the battery is reduced. Therefore, the additives in the prior art in the present field are difficult to simultaneously achieve the excellent high-temperature storage performance and high-temperature cyclic performance.

There is still a requirement to develop an electrolyte additive capable of protecting the surfaces of negative electrode of the lithium ion secondary battery and enhancing the high-temperature storage performance and high-temperature cyclic performance of the lithium ion secondary battery, an electrolyte and a lithium ion secondary battery containing such electrolyte in the field.

### SUMMARY

A main object of the present disclosure is to provide an electrolyte additive, an electrolyte and a lithium ion secondary battery containing the same, so as to solve a problem that high-temperature storage performance and high-temperature cyclic performance of the lithium ion secondary battery are poorer in the prior art.

For achieving the above object, according to one aspect of the present disclosure, an electrolyte additive is provided, the electrolyte additive has a structure of Formula (1):

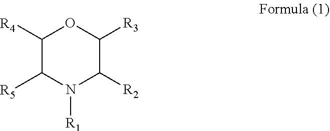

wherein R₁ is hydrogen, a phenyl, a nitrile group, a cyano group substituted by one or more C₁ to C₆ alkyls, or a C₁ to C₆ alkyl optionally substituted by one or more C₁ to C₆ alkyls or one or more C₂ to C₆ alkenyls, and each of R2 to R5 is independently selected from ydrogen or a C₁ to C₆ alkyls optionally substituted by one or more C₁ to C₆ alkyls.

Further, in the above electrolyte additive, the additive comprises a compound with a structure of Formula (1):

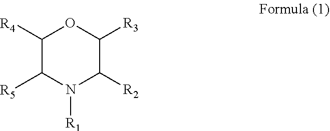

wherein R₁ is hydrogen, a phenyl, a nitrile group, an alkyl cyano group, a C₁ to C₆ alkyl substituted by one or more C₂ to C₄ alkenyls, or a C₁ to C₆ alkyl, and each of R2 to C₅ is hydrogen.

Further, in the above electrolyte additive, the additive comprises a compound with a structure of Formula (1):

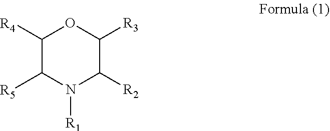

wherein R₁ is a phenyl, a nitrile group, a alkyl cyano group, an allyl, a butyl, or an ethyl, and each of R2 to R5 is hydrogen.

According to another aspect of the present disclosure, an electrolyte is provided, and the electrolyte comprises an organic solvent, a lithium salt and the electrolyte additive as described above.

Further, in the above electrolyte, an amount of the additive ranges from about 0.2 to about 3 parts by weight, based on 100 parts by weight of the organic solvent and the lithium salt.

Further, in the above electrolyte, an amount of the organic solvent ranges from about 80 to about 90 parts by weight, based on 100 parts by weight of the organic solvent and the lithium salt.

Further, in the above electrolyte, an amount of the lithium salt ranges from about 10 to about 20 parts by weight, based on 100 parts by weight of the organic solvent and the lithium salt.

Further, in the above electrolyte, the organic solvent is selected from a group consisting of ethylene carbonate, propylene carbonate, butylene carbonate, fluoroethylene carbonate, diethyl carbonate, dipropyl carbonate, ethyl methyl carbonate, carbonic acid ethylene ester dimethyl carbonate, or any combination thereof.

Further, in the above electrolyte, the lithium salt is selected from a group consisting of LiCl, LiBr, LiPF₆ , LiBF₄ , LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, or any combination thereof.

According to yet another aspect of the present disclosure, a lithium ion secondary battery is provided, and the lithium ion secondary battery comprises a positive electrode, a negative electrode, a separator, and the electrolyte as described above.

By using the electrolyte additive, the electrolyte and the lithium ion secondary battery containing the same of the present disclosure, a technical effect of simultaneously improving high-temperature storage performance and high-temperature cycle performance of the lithium ion secondary battery is achieved.

### BRIEF DESCRIPTION OF THE DRAWINGS

FIG. 1 shows the experimental results of cyclic retention rate of some examples and comparative example 2.

FIG. 2 shows the experimental results of floating charge electric quantity of some examples and comparative example 2.

### DETAILED DESCRIPTION OF THE EMBODIMENTS

It is noted that embodiments in the disclosure and features in the embodiments may be mutually combined without departing from the spirit of the disclosure. The disclosure is described in detail in combination with the embodiments below. The following embodiments are only exemplary, and are not intend to limit a scope of protection of the disclosure.

As described in the background, a lithium difluorooxalatoborate additive is generally added into an electrolyte additive of a lithium ion secondary battery in prior art, so as to form layers of a stable solid electrolyte membrane on all the surfaces of the negative electrode in a first charging-discharging process of the lithium ion secondary battery. However, the method still may not solve a problem that high-temperature storage performance and high-temperature cycle performance of the lithium ion secondary battery are poorer. As to the problem in the prior art, a typical embodiment of the present disclosure provides an electrolyte additive, the electrolyte additive has a structure of Formula (1):

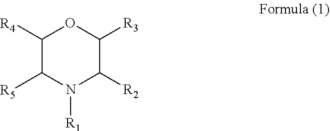

wherein R₁ is hydrogen, a phenyl, a nitrile group, an alkyl cyano group, an alkyl substituted by an alkenyl, or a C₁ to C₆ alkyl, and each of R₂ to R₅ is independently selected from hydrogen or a C₁ to C₆ alkyl.

After a larger number of experiments are performed, the inventors of the present disclosure surprisingly discover that one O atom in dioxane for forming the solid electrolyte membrane in the prior art may be replaced by a N atom, so that a morpholine structure is formed, and a solid electrolyte membrane is formed on the basis of the morpholine structure. The morpholine structure has an alkylene oxide-like structure, and due to a ring structure thereof having a N atom, it also has properties of an amino group. Compared with the electrolyte additive in the prior art, the compound of Formula (1) of the present disclosure may effectively improve the stability of the electrolyte, and the compound may form the stable solid electrolyte membrane on the surfaces of a negative electrode after a first charging-discharging cycle of the lithium ion secondary battery, thereby the cyclic stability and high-temperature storage performance of the battery are improved.

In some embodiments of the present disclosure, a R₁ group may be selected from hydrogen, a phenyl, a nitrile group, a methyl, an ethyl, an n-propyl, an isopropyl, an n-butyl, an isobutyl, a tert-butyl, an n-pentyl, an isopentyl, a neopentyl, an n-hexyl, a methanenitrile group, an acetonitrile group, an n-propionitrile group, an isopropionitrile group, an n-butyronitrile group, an isobutyronitrile group, a tert-butyronitrile group, an n-pentanenitrile group, an isopentanenitrile group, a neopentanenitrile group or an n-hexanenitrile group. In addition, in some other embodiments, R₁ group may be a C₁ to C₆ alkyl substituted by one or more C₃ to 06 cycloalkenyls or a C₁ to C₆ alkyl substituted by one or more straight-chain C₂ to C₆ alkenyls. In a further preferable embodiment, R₁ group may be selected from allyl, 3-butenyl, 4-pentenyl or 3-pentenyl.

In some embodiments of the present disclosure, the electrolyte additive may comprise one of the following substances or any combination thereof: morpholine, N-methylmorpholine, N-ethylmorpholine, N-propylmorpholine (e.g. N-n-propylmorpholine, N-isopropylmorpholine), N-butylmorpholine (e.g. N-n-butylmorpholine, N-2-isobutylmorpholine, N-tert-butylmorpholine), N-pentylmorpholine (e.g. N-n-pentylmorpholine, N-2-isopentylmorpholine, N-3-isopentylmorpholine, N-2-methyl-1-butylmorpholine, N-3-methyl-1-butylmorpholine, N-3,3-dimethyl-1-propylmorpholine), N-hexylmorpholine (e.g. N-n-hexylmorpholine), N-phenylmorpholine, N-cyanomorpholine (morpholinylacetonitrile), 2-methylmorpholine, 2-ethylmorpholine, 2-n-propylmorpholine, 2-isopropylmorpholine, 2-n-butylmorpholine, 2-(2-isobutyl)morpholine, 2-n-pentylmorpholine, 2-(2-isopentyl)morpholine, 2-n-hexylmorpholine, 2,N-dimethylmorpholine, 2-methyl-N-ethylmorpholine, 2-methyl-N-n-propylmorpholine, 2-methyl-N-n-butylmorpholine, 2-methyl-N-n-pentylmorpholine, 2-methyl-N-n-hexylmorpholine, 2-methyl-N-phenylmorpholine, 2-methyl-N-cyanomorpholine, 2-ethyl-N-methylmorpholine, 2, N-diethylmorpholine, 2-ethyl-N-propylmorpholine, 2-ethyl-N-n-butylmorpholine, 2-ethyl-N-n-pentylmorpholine, 2-ethyl-N-n-hexylmorpholine, 2-ethyl-N-phenylmorpholine, 2-ethyl-N-nitrilemorpholine, 2,3,N-trimethylmorpholine, 2,5,N-trimethylmorpholine, 2,6,N-trimethylmorpholine, 2,3-diethyl-N-methylmorpholine, 2,5-diethyl-N-methylmorpholine, 2,6-diethyl-N-methylmorpholine, 2,3-dimethyl-N-ethylmorpholine, 2,3-dimethyl-N-phenylmorpholine, 2,3-dimethyl-N-cyanomorpholine, 2,3,5-trimethyl-N-ethylmorpholine, 2,3,5-trimethyl-N-phenylmorpholine, 2,3,5-trimethyl-N-cyanomorpholine, 2,3,5,6-tetramethyl-N-ethylmorpholine, 2,3,5,6-tetramethyl-N-phenylmorpholine, 2,3,5,6-tetramethyl-N-cyanomorpholine, 2,N-diethylmorpholine, 2-propyl-N-ethylmorpholine, 2-n-butyl-N-ethylmorpholine, 2-n-pentyl-N-ethylmorpholine, 2-n-hexyl-N-ethylmorpholine, N-methylcyanomorpholine, N-ethylnitrilemorpholine, N-propylnitrilemorpholine, N-butylnitrilemorpholine, 2-methyl-N-methylnitrilemorpholine, 2-ethyl-N-methylnitrilemorpholine, 2-propyl-N-methylcyanomorpholine, 2,3-dimethyl-N-methylnitrilemorpholine, 2,5-dimethyl-N-methylnitrilemorpholine, and 2,6-dimethyl-N-methylnitrilemorpholine.

Preferably, in some embodiments, the electrolyte additive may comprise one of the following substances or any combination thereof: morpholine, N-methylmorpholine, N-ethylmorpholine, N-propylmorpholine (e.g. N-n-propylmorpholine, N-isopropylmorpholine), N-butylmorpholine (e.g. N-n-butylmorpholine, N-2-isobutylmorpholine, N-tert-butylmorpholine), N-pentylmorpholine (e.g. N-n-pentylmorpholine, N-2-isopentylmorpholine, N-3-isopentylmorpholine, N-2-methyl-1-butylmorpholine, N-3-methyl-1-butylmorpholine, N-3,3-dimethyl-1-propylmorpholine), N-hexylmorpholine (e.g. N-n-hexylmorpholine), N-phenylmorpholine, and N-cyanomorpholine.

In a further preferable embodiment, the electrolyte additive may ccomprise one of the following substances or any combination thereof: N-phenylmorpholine, N-ethylmorpholine, N-cyanomorpholine, N-n-butylmorpholine, and N-allylmorpholine.

In the embodiment that the electrolyte additive comprises the N-cyanomorpholine, after charging-discharging cycles are firstly performed on the lithium ion secondary battery, the N-cyanomorpholine in the electrolyte is polymerized on the surfaces of negative electrode so as to form a solid electrolyte membrane. In addition, since the structure of N-cyanomorpholine contains a nitrile group, the compound may be complexed with a transition metal in the electrolyte, and deposited on a positive electrode of the lithium ion secondary battery, so as to form a positive electrode protecting membrane. Therefore, in the embodiment, N-cyanomorpholine may form the protecting membranes on the positive electrode and the negative electrode so that the cyclic stability and the high-temperature storage performance of the lithium ion secondary battery are more effectively improved. In addition, in the embodiment, “N-cyanomorpholine” is only exemplarily shown, and in the case that R₁ in the compound of Formula (1) of the present disclosure is a nitrile group, all compounds meeting the above conditions may achieve effects that the N-cyanomorpholine forms the protecting membranes on the negative electrode and the positive electrode and the battery performance is effectively improved.

In another typical embodiment of the present disclosure, an electrolyte is provided, and the electrolyte comprises an organic solvent, a lithium salt and the electrolyte additive as described above. Since the electrolyte additive of the present disclosure is contained, the electrolyte of the present disclosure has the higher stability, and while the electrolyte of the present disclosure is used, after a first charging-discharging cycle, a stable solid electrolyte membrane is formed on the surfaces of a negative electrode. The solid electrolyte membrane formed by polymerizing a compound of Formula (1) of the present disclosure is a good conductor for Li⁺ ions. Compared with a solid electrolyte membrane in prior art, the solid electrolyte membrane formed by the compound of Formula (1) of the present disclosure is more beneficial to enable Li⁺ ions to be freely inserted or de-inserted in the surfaces of negative electrode. In addition, the solid electrolyte membrane in the present disclosure is insoluble in an organic solvent, and it keeps stable property during a high-temperature or a high-voltage using period of a battery. Thus, the problems that battery cyclic performance is reduced because of inserting of solvent molecules and a battery aging speed is very quick are effectively avoided.

In some embodiments of the present disclosure, in electrolyte of the present disclosure, an amount of an additive ranges from about 0.2 to about 3 parts by weight, based on 100 parts by weight of an organic solvent and a lithium salt. In the above range, the electrolyte additive may effectively form a solid electrolyte membrane. While the amount of the electrolyte additive is less than about 0.2 parts by weight, the electrolyte additive in the electrolyte is not enough to form the complete solid electrolyte membrane on the surfaces of negative electrode, thereby cyclic performance of a battery is reduced; and while the amount of the electrolyte additive is higher than about 3 parts by weight, the amount of the electrolyte additive in the electrolyte is excessive, so that a thickness of the solid electrolyte membrane formed on the surfaces of negative electrode is oversized, and inserting and de-inserting efficiency of lithium ions is affected.

In the different embodiments of the present disclosure, according to different combinations of the lithium salt and the organic solvent, a minimum value of the amount of the electrolyte additive in the electrolyte may be greater than about 0.2 parts by weight, about 0.3 parts by weight, about 0.4 parts by weight, about 0.5 parts by weight, about 0.6 parts by weight, about 0.7 parts by weight, about 0.8 parts by weight, about 0.9 parts by weight, about 1.0 parts by weight, about 1.1 parts by weight, about 1.2 parts by weight, about 1.3 parts by weight, about 1.4 parts by weight or about 1.5 parts by weight, based on the total amount of 100 parts of the organic solvent and the lithium salt by weight. In addition, according to the different combinations of the lithium salt and the organic solvent, a maximum value of the amount of the electrolyte additive in the electrolyte may be less than about 3.0 parts by weight, about 2.9 parts by weight, about 2.8 parts by weight, about 2.7 parts by weight, about 2.6 parts by weight, about 2.5 parts by weight, about 2.4 parts by weight, about 2.3 parts by weight, about 2.2 parts by weight, about 2.1 parts by weight, about 2.0 parts by weight, about 1.9 parts by weight, about 1.8 parts by weight, about 1.7 parts by weight or about 1.6 parts by weight, based on the total amount of 100 parts by weight of the organic solvent and the lithium salt.

Specifically, the amount of the electrolyte additive in the electrolyte may be within the following range: from about 0.2 parts by weight to about 3.0 parts by weight, from about 0.2 parts by weight to about 2.9 parts by weight, from about 0.3 parts by weight to about 2.8 parts by weight, from about 0.4 parts by weight to about 2.7 parts by weight, from about 0.5 parts by weight to about 2.6 parts by weight, from about 0.6 parts by weight to about 2.5 parts by weight, from about 0.7 by weight to about 2.4 parts by weight, from about 0.8 parts by weight to about 2.3 parts by weight, from about 0.9 parts by weight to about 2.2 parts by weight, from about 1.0 parts by weight to about 2.1 parts by weight, from about 1.1 parts by weight to about 2.0 parts by weight, from about 1.2 parts by weight to about 1.9 parts by weight, from about 1.3 parts by weight to about 1.8 parts by weight, from about 1.4 parts by weight to about 1.7 parts by weight, from about 1.5 parts by weight to about 1.6 parts by weight, from about 0.3 parts by weight to about 1.0 parts by weight, from about 0.2 parts by weight to about 1.0 parts by weight, from about 1.0 parts by weight to about 2.0 parts by weight, from about 2.0 parts by weight to about 3.0 by weight, from about 1.5 parts by weight to about 2.0 parts by weight, from about 1.5 parts by weight to about 2.5 parts by weight or from about 2.0 parts by weight to about 2.5 parts by weight, based on the total amount of 100 parts by weight of the organic solvent and the lithium salt.

In some embodiments of the electrolyte of the present disclosure, the amount of the organic solvent is within a range from about 80 parts by weight to about 90 parts by weight, based on 100 parts by weight of the organic solvent and the lithium salt. In addition, the amount of the lithium salt is within a range from about 10 parts by weight to about 20 parts by weight. In the above range, the lithium salt and the organic solvent may form a non-aqueous electrolyte system well, and after the electrolyte additive of the present disclosure in the amount described previously is added, the formed electrolyte system may form a good solid electrolyte membrane after a first electric cycle. In addition, lithium ions formed in the amount of the lithium salt within the above range may perform inserting and de-inserting in the most effective amount, thereby the cyclic efficiency of the lithium ion secondary battery is improved.

In the present disclosure, the organic solvent of the non-aqueous electrolyte may be any non-aqueous solvents which are used for non-aqueous electrolyte solution so far. Instances include but not limited to: linear or cyclic carbonates, such as ethylene carbonate, propylene carbonate, butylene carbonate, diethyl carbonate, dimethyl carbonate, ethyl methyl carbonate, dipropyl carbonate, and fluoroethylene carbonate; ethers, such as 1,2-dimethoxyethane, 1,2-diethoxyethane, Gamma-butyrolactone, tetrahydrofuran, 2-methyltetrahydrofuran, 1,3-dioxolane, 4-methyl-1,3-dioxolane, and diethyl ether; sulfones, such as sulfolane, and methyl sulfolane; nitriles, such as acetonitrile, and propionitrile; and esters, such as acetate, propionate, and butyrate, and the like. These non-aqueous solvents may be separately used or at least two solvents are combined to be used. In some embodiments of the present disclosure, a preferable electrolyte comprises ethylene carbonate, propylene carbonate, butylene carbonate, fluoroethylene carbonate, diethyl carbonate, dipropyl carbonate, ethyl methyl carbonate, carbonic acid ethylene ester and/or dimethyl carbonate, or any combination thereof. In a preferable embodiment, at least one carbonic ester is used as the organic solvent of the electrolyte of the present disclosure. In some other preferable embodiments, the above non-aqueous solvents may be arbitrarily used and combined so as to form the electrolyte solution in accordance with different requirements.

In the present disclosure, no special limitation for a lithium salt component contained in the electrolyte, and the known lithium salt in prior art which may be used for a lithium battery electrolyte may be adopted. The examples of the lithium salt include but not limited to LiCl, LiBr, LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄ and/or LiSiF₆, or any combination thereof.

In another typical embodiment of the present disclosure, a lithium ion secondary battery is provided, and the lithium ion secondary battery comprises: a positive electrode, a negative electrode, a separator, and the electrolyte as described above. Because the lithium ion secondary battery of the present disclosure uses the electrolyte as described above, the lithium ion secondary battery has excellent electric performance at high-temperature and high-voltage.

The positive electrode of the present disclosure comprises a positive electrode current collector and a positive electrode active substance layer containing a positive electrode active substance. The positive electrode active substance layer is formed on two surfaces of the positive electrode current collector. Metal foil, such as aluminum foil, nickel foil and stainless steel foil, may be used as the positive electrode current collector.

The positive electrode active substance layer contains one, two or more of positive electrode materials which are used as the positive electrode active substance and are capable of absorbing and releasing lithium ions, and if necessary, other materials may be contained, for example a positive electrode binder and/or a positive electrode conductive agent.

Preferably, the positive electrode material is a lithium-containing compound. Instances of the lithium-containing compound include a lithium-transition metal composite oxide, a lithium-transition metal phosphate compound, and the like. The lithium-transition metal composite oxide is an oxide containing Li and one, or two or more of the transition metals which are used as composition elements, and the lithium-transition metal phosphate compound is a phosphate compound containing Li and one, or two or more of transition metal which are used as the composition elements. In such compounds, the transition metal is advantageously any one, or two or more of Co, Ni, Mn, Fe, and the like.

Instances of the lithium-transition metal composite oxide include LiCoO₂, LiNiO₂, and the like. Instances of the lithium-transition metal phosphate compound include, for example LiFePO₄, LiFe₁₋ᵤMnᵤPO₄ (u is less than 1), and the like.

In addition, the positive electrode material may be, for example any one, or two or more of an oxide, a disulfide, a chalcogen compound, a conductive polymer, and the like. Instances of the oxide include, for example a titanium oxide, a vanadium oxide, manganese dioxide, and the like. Instances of the disulfide include, for example titanium disulfide, molybdenum sulfide, and the like. Instances of the chalcogen compound include, for example niobium selenide and the like. Instances of the conductive polymer include, for example sulfur, polyaniline, polythiophene, and the like. However, the positive electrode material may be a material different from those mentioned above.

An instance of the positive electrode conductive agent includes a carbon material, for example graphite, carbon black, acetylene black, and Ketjen black. These may be independently used, or two or more of them may be mixed for using. It is to be noted that the positive electrode conductive agent may be a metal material, a conductive polymer, or an analogue, only if it has electrical conductivity.

Instances of the positive electrode binder include synthetic rubber and a polymer material. For example, the synthetic rubber may be styrene butadiene rubber, fluororubber and ethylene-propylene-diene rubber. For example, the polymer material may be polyvinylidene fluoride and polyimide. These may be independently used, or two or more of them may be mixed for using.

The negative electrode of the present disclosure includes a negative electrode current collector and a negative electrode active substance layer containing a negative electrode active substance. The negative electrode active substance layer is formed on two surfaces of the negative electrode current collector. A metal foil, such as a copper (Cu) foil, a nickel foil, or a stainless steel foil, may be used as the negative electrode current collector.

The negative electrode active substance layer contains a material which is used as the negative electrode active substance and is capable of absorbing and releasing lithium ions, and may contain another material if necessary, for example a negative electrode binder and a negative electrode conductive agent. Details of the negative electrode binder and the negative electrode conductive agent are the same as that of the positive electrode binder and the positive electrode conductive agent for example.

The negative electrode active substance is a carbonaceus material containing graphite. Because the carbonaceus material has a low electric potential when lithium ions are absorbed, high energy density may be achieved, and battery capacity may be increased. Furthermore, the carbonaceus material also acts as the conductive agent. This type of the carbonaceus material is a material or an analogue obtained by coating a natural graphite and an artificial graphite, for example, with amorphous carbon. It is to be noted that a shape of the carbonaceus material is a fiber form, a spherical shape, a granular form, a flake form, or a similar shape.

Besides, the negative electrode material may be one, or two or more of easy-graphited carbon, difficult-graphited carbon, a metallic oxide, a polymer compound, and the like. Instances of the metallic oxide include an iron oxide, a ruthenium oxide, a molybdenum oxide, and the like. Instances of the polymer compound include polyacetylene, polyaniline, polypyrrole, and the like. However, the negative electrode material may be another material different from those as described above.

The separator of the present disclosure is used for separating the positive electrode and the negative electrode in the battery, and enabling ions to pass through, at the same time preventing current short circuit caused by contact between the two electrode pieces. The separator may be, for example, a porous membrane formed by synthetic resin, ceramic, or similar substances, and a laminating membrane laminated by two or more porous membranes. Instances of the synthetic resin include polytetrafluoroethylene, polypropylene, polyethylene, and the like.

In the embodiment of the present disclosure, when charging is performed, for example, lithium ions are released from the positive electrode and absorbed in the negative electrode through the non-aqueous electrolyte dipping in the separator. While discharging is performed, for example, the lithium ions are released from the negative electrode and absorbed in the positive electrode through the non-aqueous electrolyte impregnating with the separator.

The present disclosure is further described in detail in combination with specific examples below, these examples may not be understood to limit a scope of protection required by the present disclosure.

Preparation of Electrolyte

### EXAMPLE 1

15 g of ethylene carbonate and 70 g of dimethyl carbonate are mixed with 15 g of lithium hexafluorophosphate so as to prepare a base electrolyte. 0.2 g of N-ethylmorpholine is added into the electrolyte. After uniformly stirring, it is used for standby application.

### EXAMPLE 2

15 g of ethylene carbonate and 70 g of dimethyl carbonate are mixed with 15 g of lithium hexafluorophosphate so as to prepare a base electrolyte. 1 g of N-ethylmorpholine is added into the electrolyte. After uniformly stirring, it is used for standby application.

### EXAMPLE 3

15 g of ethylene carbonate and 70 g of dimethyl carbonate are mixed with 15 g of lithium hexafluorophosphate so as to prepare a base electrolyte. 3 g of N-ethylmorpholine is added into the electrolyte. After uniformly stirring, it is used for standby application.

### EXAMPLE 4

15 g of ethylene carbonate and 70 g of dimethyl carbonate are mixed with 15 g of lithium hexafluorophosphate so as to prepare a base electrolyte. 0.2 g of morpholineacetonitrile is added into the electrolyte. After uniformly stirring, it is used for standby application.

### EXAMPLE 5

15 g of ethylene carbonate and 70 g of dimethyl carbonate are mixed with 15 g of lithium hexafluorophosphate so as to prepare a base electrolyte. 1 g of morpholinoacetonitrile is added into the electrolyte. After uniformly stirring, it is used for standby application.

### EXAMPLE 6

15 g of ethylene carbonate and 70 g of dimethyl carbonate are mixed with 15 g of lithium hexafluorophosphate so as to prepare a base electrolyte. 3 g of morpholinoacetonitrile is added into the electrolyte. After uniformly stirring, it is used for standby application.

### EXAMPLE 7

15 g of ethylene carbonate and 70 g of dimethyl carbonate are mixed with 15 g of lithium hexafluorophosphate so as to prepare a base electrolyte. 0.2 g of N-phenylmorpholine is added into the electrolyte. After uniformly stirring, it is used for standby application.

### EXAMPLE 8

15 g of ethylene carbonate and 70 g of dimethyl carbonate are mixed with 15 g of lithium hexafluorophosphate so as to prepare a base electrolyte. 1 g of N-phenylmorpholine is added into the electrolyte. After uniformly stirring, it is used for standby application.

### EXAMPLE 9

15 g of ethylene carbonate and 70 g of dimethyl carbonate are mixed with 15 g of lithium hexafluorophosphate so as to prepare a base electrolyte. 3 g of N-phenylmorpholine is added into the electrolyte. After uniformly stirring, it is used for standby application.

### EXAMPLE 10

15 g of ethylene carbonate and 70 g of dimethyl carbonate are mixed with 15 g of lithium hexafluorophosphate so as to prepare a base electrolyte. 1 g of N-butylmorpholine is added into the electrolyte. After uniformly stirring, it is used for standby application.

### EXAMPLE 11

15 g of ethylene carbonate and 70 g of dimethyl carbonate are mixed with 15 g of lithium hexafluorophosphate so as to prepare a base electrolyte. 1 g of N-allylmorpholine is added into the electrolyte. After uniformly stirring, it is used for standby application.

### COMPARATIVE EXAMPLE 1

15 g of ethylene carbonate and 70 g of dimethyl carbonate are mixed with 15 g of lithium hexafluorophosphate so as to prepare a base electrolyte. Any other additives are not added into the obtained base electrolyte.

Preparation of Battery

### EXAMPLE 12

Preparation of Positive Electrode

92 g of lithium cobaltate of a positive electrode active substance, 5 g of a graphite conductive agent, and 3 g of a polyvinylidene fluoride binder are mixed to obtain a positive electrode mixture, and the obtained positive electrode mixture is dispersed in 33 g of N-methyl pyrrolidone to obtain a positive electrode mixture slurry. After that, the surfaces of an aluminum foil are coated by the positive electrode mixture slurry to obtain a positive electrode current collector. The positive electrode current collector is dried, and a positive electrode piece is formed by using a punch-forming process.

Preparation of Negative Electrode

97 g of graphite powder, 2 g of butadiene styrene rubber, 1 g of carboxymethylcellulose are added into a certain amount of water and stirring is performed to form negative electrode slurry. After that, the surfaces of a copper foil are uniformly coated by the obtained negative electrode slurry to obtain a negative electrode current collector. The negative electrode current collector is dried and a negative electrode piece is formed by using the punch-forming process.

Assembly of Battery

A CR2016 button battery is assembled in a dry laboratory. The positive electrode piece obtained in the above steps is used as a positive electrode, the negative electrode piece obtained in the above steps is used as a negative electrode, and the electrolyte prepared in Example 1 is used as electrolyte. The positive electrode, the negative electrode and the separator are assembled with a battery case of the button battery. After being assembled, the battery rests for 24 h to be aged, thereby a lithium cobaltate button battery is obtained.

### EXAMPLE 13

A button battery is prepared similarly to Example 12, a difference is that the electrolyte prepared in Example 2 is used as electrolyte of the button battery prepared in Example 13.

### EXAMPLE 14

A button battery is prepared similarly to Example 12, a difference is that the electrolyte prepared in Example 3 is used as electrolyte of the button battery prepared in Example 14.

### EXAMPLE 15

A button battery is prepared similarly to Example 12, a difference is that the electrolyte prepared in Example 4 is used as electrolyte of the button battery prepared in Example 15.

### EXAMPLE 16

A button battery is prepared similarly to Example 12, a difference is that the electrolyte prepared in Example 5 is used as electrolyte of the button battery prepared in Example 16.

### EXAMPLE 17

A button battery is prepared similarly to Example 12, a difference is that the electrolyte prepared in Example 6 is used as electrolyte of the button battery prepared in Example 17.

### EXAMPLE 18

A button battery is prepared similarly to Example 12, a difference is that the electrolyte prepared in Example 7 is used as electrolyte of the button battery prepared in Example 18.

### EXAMPLE 19

A button battery is prepared similarly to Example 12, a difference is that the electrolyte prepared in Example 8 is used as electrolyte of the button battery prepared in Example 19.

### EXAMPLE 20

A button battery is prepared similarly to Example 12, a difference is that the electrolyte prepared in Example 9 is used as electrolyte of the button battery prepared in Example 20.

### EXAMPLE 21

A button battery is prepared similarly to Example 12, a difference is that the electrolyte prepared in Example 10 is used as electrolyte of the button battery prepared in Eample 21.

### EXAMPLE 22

A button battery is prepared similarly to Example 12, a difference is that the electrolyte prepared in Example 11 is used as electrolyte of the button battery prepared in Example 22.

### COMPARATIVE EXAMPLE 2

A button battery is prepared similarly to Example 12, a difference is that the electrolyte prepared in Comparative Example 1 is used as electrolyte of the button battery prepared in Comparative Example 2.

Test of Battery Performance

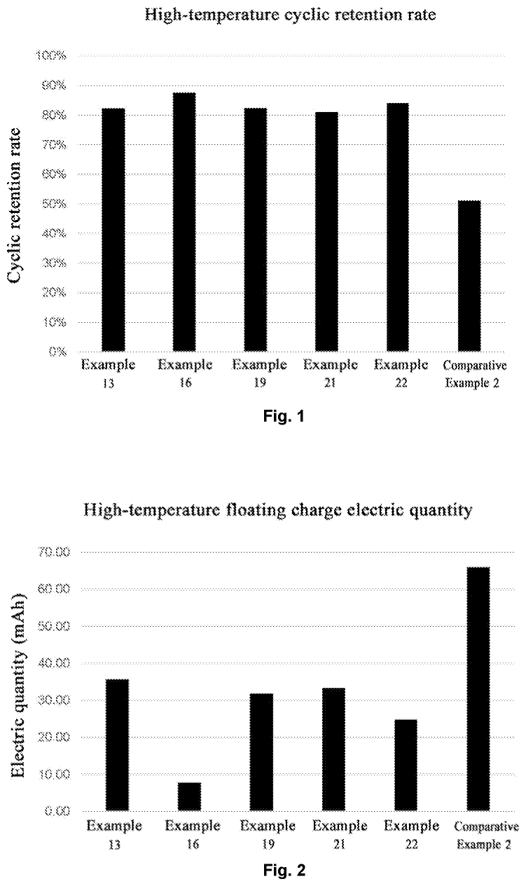

Firstly, parallel tests of charging-discharging are performed on the button batteries of Examples 11-18 and Comparative Example 2 at room temperature, at a voltage between 3 V and 4.45 V. After that, the batteries are grouped, a 1 C cyclic test is performed on one group of the batteries at 45° C. for 60 circles, thereby a capacity retention rate thereof is determined. A floating charge test is performed on the other group of the batteries at 60° C., and a charging voltage is set to be 4.45 V, and a floating charge electric quantity is measured. Experiment results are shown in Table 1, and FIG. 1 and FIG. 2. Wherein, the battery with the larger floating charge electric quantity is poorer in performance.

TABLE 1
battery performance testing results

| | | | | Floating |
|---|---|---|---|---|
| | | | | charge |
| | | | Cyclic | electric |
| | | Addition | retention | quantity |
| Example | Additive | amount | rate | (mAh) |
| Example 12 | N-ethylmorpholine | 0.2% | 68% | 43.45 |
| Example 13 | N-ethylmorpholine | 1.0% | 82% | 35.58 |
| Example 14 | N-ethylmorpholine | 3.0% | 66% | 24.32 |
| Example 15 | Morpholinoacetonitrile | 0.2% | 73% | 7.93 |
| Example 16 | Morpholinoacetonitrile | 1.0% | 88% | 7.64 |
| Example 17 | Morpholinoacetonitrile | 3.0% | 77% | 6.81 |
| Example 18 | N-phenylmorpholine | 0.2% | 67% | 34.92 |
| Example 19 | N-phenylmorpholine | 1.0% | 82% | 31.73 |
| Example 20 | N-phenylmorpholine | 3.0% | 54% | 19.39 |
| Example 21 | N-butylmorpholine | 1.0% | 81% | 33.20 |
| Example 22 | N-allylmorpholine | 1.0% | 84% | 24.70 |
| Comparative | | | 51% | 65.94 |
| Example 2 | | | | |

In Table 1, the “addition amount” is a weight percentage of the additive based on a total weight of the base electrolyte.

It may be observed from the above testing results that the above examples of the present disclosure achieve the following technical effects.

It may be observed from the experiment results that the lithium ion secondary battery of Examples 12-22 of which the electrolyte is added with the additive with the structural of Formula (1) of the present disclosure is more excellent in electrical performance, wherein a morpholine body structure is preferentially reduced to form the membrane on the surfaces of negative electrode, the deposition of the transition metal on the negative electrode and reductive decomposition of the electrolyte are inhibited.

While the addition amount of the electrolyte additive of the present disclosure is excessively less, the membrane formation of the negative electrode is inadequate, and it is difficult to achieve a function of inhibiting the deposition of the transition metal on the negative electrode and the reductive decomposition of the electrolyte. While the addition amount of the electrolyte additive of the present disclosure is excessively more, although dissolution of the transition metal may be inhibited better, because the formed membrane is excessively thick, the battery impedance is ncreased, thereby the cyclic performance is reduced.

In addition, because the cyano group of the morpholinoacetonitrile may also be complexed on the positive electrode surfaces, the positive electrode is further protected, thereby the cyclic stability of the battery is improved, and the cyclic performance and the high-temperature performance of the battery may also be improved. Therefore, the floating charge electric quantities of Examples 15-17 are superior to those of Examples 12-14, Examples 18-22 and Comparative Example 2.

It may be observed from the above battery performance testing results that the lithium ion secondary battery containing the electrolyte additive of the present disclosure demonstrates the excellent effects in aspects of high-temperature cyclic stability and high-temperature floating charge electric quantity.

The above descriptions are only the optimal examples of the present disclosure, and are not intend to limit the present disclosure, various changes and modifications may be made to the present disclosure by those skilled in the art. Within spirits and principles of the present disclosure, any modifications, equivalent replacements, improvements, and the like shall fall within the scope of protection of the present disclosure.

What is claimed is:

1. An electrolyte additive having a structure of Formula (1): 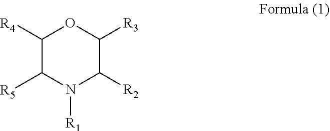
wherein R₁ is hydrogen, a phenyl, a nitrile group, a cyano group substituted by one or more C₁ to C₆ alkyls, or a C₁ to C₆ alkyl optionally substituted by one or more C₁ to C₆ alkyls or one or more C₂ to C₆ alkenyls, and each of R2 to R5 is independently selected from hydrogen or a C₁ to C₆ alkyl optionally substituted by one or more C₁ to C₆ alkyls.

2. The electrolyte additive as claimed in claim 1, wherein the additive comprises a compound with a structure of Formula (1): 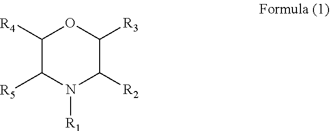
wherein, R₁ is hydrogen, a phenyl, an alkyl cyano group, a nitrile group, a C₁ to C₆ alkyl substituted by one or more C₂ to C₄ alkenyls, or a C₁ to C₆ alkyl, and
each of R2 to R5 is hydrogen.

3. The electrolyte additive as claimed in claim 1, wherein the additive comprises a compound with a structure of Formula (1): 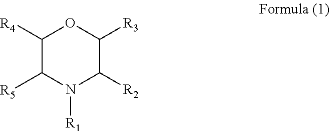
wherein R₁ is a phenyl, a nitrile group, an alkyl cyano group, an allyl, a butyl, or a ethyl, and
each of R2 to R5 is hydrogen.

4. An electrolyte, which comprises an organic solvent, a lithium salt and the electrolyte additive as claimed in claim 1.

5. The electrolyte as claimed in claim 4, wherein an amount of the electrolyte additive ranges from about 0.2 to about 3 parts by weight, based on 100 parts by weight of the organic solvent and the lithium salt.

6. The electrolyte as claimed in claim 4, wherein an amount of the organic solvent ranges from about 80 to about 90 parts by weight, based on 100 parts by weight of the organic solvent and the lithium salt.

7. The electrolyte as claimed in claim 5, wherein an amount of the organic solvent ranges from about 80 to about 90 parts by weight, based on 100 parts by weight of the organic solvent and the lithium salt.

8. The electrolyte as claimed in claim 4, wherein an amount of the lithium salt ranges from about 10 to about 20 parts by weight, based on 100 parts by weight of the organic solvent and the lithium salt.

9. The electrolyte as claimed in claim 5, wherein an amount of the lithium salt ranges from about 10 to about 20 parts by weight, based on 100 parts by weight of the organic solvent and the lithium salt.

10. The electrolyte as claimed in claim 4, wherein the organic solvent is selected from a group consisting of ethylene carbonate, propylene carbonate, butylene carbonate, fluoroethylene carbonate, diethyl carbonate, dipropyl carbonate, ethyl methyl carbonate, carbonic acid ethylene ester, dimethyl carbonate, or any combination thereof.

11. The electrolyte as claimed in claim 5, wherein the organic solvent is selected from a group consisting of ethylene carbonate, propylene carbonate, butylene carbonate, fluoroethylene carbonate, diethyl carbonate, dipropyl carbonate, ethyl methyl carbonate, carbonic acid ethylene ester, dimethyl carbonate, or any combination thereof.

12. The electrolyte as claimed in claim 4, wherein the lithium salt is selected from a group consisting of LiCl, LiBr, LiPF₆, LiBF₄, LiAsF₆, LiClO₄, LiB(C₆H₆)₄, LiCH₃SO₃, LiCF₃SO₃, LiN(SO₂CF₃)₂, LiC(SO₂CF₃)₃, LiAlCl₄, LiSiF₆, or any combination thereof.

13. The electrolyte as claimed in claim 5, wherein the lithium salt is selected from a group consisting of LiCl, LiBr, LiPF₆, LiBF₄, LiAsF₆, LiClO₄, LiB(C₆H₆)₄, LiCH₃SO₃, LiCF₃SO₃, LiN(SO₂CF₃)₂, LiC(SO₂CF₃)₃, LiAlCl₄, LiSiF₆, or any combination thereof.

14. A lithium ion secondary battery, which comprises:
a positive electrode,
a negative electrode,
a separator, and
the electrolyte as claimed in claim 4.

15. The lithium ion secondary battery as claimed in claim 14, wherein an amount of the electrolyte additive in the electrolyte ranges from about 0.2 to about 3 parts by weight, based on 100 parts by weight of the organic solvent and the lithium salt.

16. The lithium ion secondary battery as claimed in claim 14, wherein an amount of the organic solvent in the electrolyte ranges from about 80 to about 90 parts by weight, based on 100 parts by weight of the organic solvent and the lithium salt.

17. The lithium ion secondary battery as claimed in claim 14, wherein an amount of the lithium salt in the electrolyte ranges from about 10 to about 20 parts by weight, based on 100 parts by weight of the organic solvent and the lithium salt.

18. The lithium ion secondary battery as claimed in claim 14, wherein the organic solvent in the electrolyte is selected from a group consisting of ethylene carbonate, propylene carbonate, butylene carbonate, fluoroethylene carbonate, diethyl carbonate, dipropyl carbonate, ethyl methyl carbonate, carbonic acid ethylene ester, dimethyl carbonate, or any combination thereof.

19. The lithium ion secondary battery as claimed in claim 14, wherein the lithium salt in the electrolyte is selected from a group consisting of LiCl, LiBr, LiPF₆, LiBF₄, LiAsF₆, LiClO₄, LiB(C₆H₆)₄, LiCH₃SO₃, LiCF₃SO₃, LiN(SO₂CF₃)₂, LiC(SO₂CF₃)₃, LiAlCl₄, LiSiF₆, or any combination thereof.
